(19) United States
(12) Patent Application Publication
(10) Pub. No.: US 2025/0144546 A1
(43) Pub. Date: May 8, 2025

(54) INTEGRATED OPTIMIZED HORIZONTAL BOXED AMINE CARBON CAPTURE SYSTEM FOR POST COMBUSTION EMISSIONS

(71) Applicant: PETRONAS Energy Canada Ltd., Calgary (CA)

(72) Inventors: Ian BUCHANAN, Calgary (CA); Darius REMESAT, Calgary (CA); Austin JACKSON, Calgary (CA)

(21) Appl. No.: 18/938,657

(22) Filed: Nov. 6, 2024

(30) Foreign Application Priority Data
Nov. 6, 2023 (CA) 3218936

(51) Int. Cl. B01D 5/00; B01D 53/14

(52) U.S. Cl. CPC B01D 5/0072; B01D 53/1431; B01D 53/1493; B01D 2257/504; B01D 2258/01

(57) ABSTRACT

A series of connected vertical contactors arranged horizontally, that are a compact and lower weight boxed arrangement integrated in multiple processing steps to treat engine exhaust to capture carbon dioxide. A direct contact cooler, optional gas scrubber, liquid CO₂ absorbent (e.g., amine) absorption and optional water wash are combined in one overall integrated vessel, separated by internal chambers that is organized horizontally to reduce the weight (and cost) of construction through modular, reduced footprint, lower pump heads, with common internal walls and thinner material of constructions.

### FIELD OF THE INVENTION

The present invention is directed to a system for carbon capture, more specifically, a system for the carbon capture from post combustion emissions.

### BACKGROUND OF THE INVENTION

Carbon capture on high pressure streams is well established. For low pressure streams such as internal combustion engines using natural gas and/or diesel to power processing equipment limited economical commercial applications for carbon capture are available. A few commercial applications for Carbon capture on combusted coal are practiced though. In all of the above cases, the cost of carbon capture is still a challenge even with increasing carbon taxes. The novel concept presented reduces the cost of carbon capture on low pressure streams by creating a method and apparatus that only requires thin-walled vessels and reduces the number of vessel walls by sharing walls between processes. By applying the novel concept, the cost of carbon capture processes will become competitive with upcoming carbon taxes in Canada (2030 onward).

US patent application 2020/0289975 A1 shows a boxed arrangement for an amine contactor as a stand-alone operation. This application does not teach the combination of the multiple steps for a CO₂ capture process into one vessel.

Typical large low pressure CO₂ capture facilities, like the Boundary Dam Saskatchewan CO₂ capture facility, have a vertically stacked box amine contactor and water wash vessel. This open art installation does not teach a horizontal arrangement to reduce vessel material and install cost and doesn't include a direct contact cooler into the single vessel.

International patent application WO 00/64553 A3 shares a horizontal distillation columns for a single operation. This application does not teach the combination of multiple steps for a CO₂ capture process into one vessel.

In light of the state of the art, there still exists a need for improved processes for carbon capture, especially for post combustion emissions.

### SUMMARY OF THE INVENTION

According to as aspect of the present invention, there is provided an improved method and apparatus to capture carbon dioxide from a post combustion exhaust, such as an engine, has been developed. Preferably, the process takes hot exhaust through ducting to a rectangular boxed, and horizontally connected and arranged series of vertical contactor vessels. Firstly, the engine exhaust can be cooled with a direct counter current contact water spray using mass and heat transfer arrangement in an internal chamber. The cooled exhaust is then directed through an internal channel to a second internal chamber to be contacted by a direct counter current contact chilled lean liquid CO₂ absorbent (e.g. amine) spray using mass transfer arrangement to capture carbon dioxide. The carbon dioxide reduced exhaust stream can then be directed through another internal channel to a third or more internal chamber(s) to be contacted a second or more time(s) by a direct counter current contact chilled lean liquid CO2 absorbent (e.g. amine) to remove additional carbon dioxide. The further carbon dioxide depleted exhaust stream can be directed through another internal channel to a subsequent (optional) internal chamber to be contacted by a direct counter current contact water spray and mass transfer arrangement to prevent entrained liquid CO₂ absorbent liquid from leaving the vessel to atmosphere.

According to an aspect of the present invention, there is provided a process to capture carbon dioxide from post-combustion exhaust, such as from an engine, that only requires thin-walled vessels and reduces the number of vessel walls by sharing walls between process steps such as:
direct contact cooling and water condensation and removal in the first chamber;
liquid absorption to capture carbon dioxide in one or more chambers;
water wash to prevent any liquid absorbent from leaving with the exhaust gas;
   integrated with water recycle and liquid absorbent regeneration.

According to a preferred embodiment of the present invention, the pressure drop across each step is less than 1.5 kPa. More preferably, the pressure drop across the process is less than 6 kPa.

According to a preferred embodiment of the present invention, the vessel walls are thinner than 2.7 mm. According to a preferred embodiment of the present invention, the vessel height is less than the road transport height limit, 7 m. Preferably, the vessel material can be steel, wood, or plastic.

According to a preferred embodiment of the present invention, the liquid absorbent can be a combination of one or all of amine, carbonate, propanediol and piperazine.

According to a preferred embodiment of the present invention, the internal supports also serve as process baffles. Preferably, the internal channels contain a demisting device to agglomerate any entrained liquids from the upstream chamber.

According to another aspect of the present invention, there is provided an apparatus to capture carbon dioxide from a post combustion exhaust, such as from an engine, through the means of;
feeding hot exhaust through ducting or piping to a rectangular boxed, and horizontally arranged series of vertical contactor vessels;
cooling the engine exhaust with a direct counter current contact water spray using mass and heat transfer arrangement in an internal chamber;
directing the cooled exhaust through an internal channel to a second internal chamber to be contacted by a direct counter current contact chilled lean liquid CO₂ absorbent (e.g., amine) spray using mass transfer arrangement to capture carbon dioxide;
directing the carbon dioxide reduced exhaust stream through another internal channel to a third or more internal chamber(s) to be contacted a second or more time(s) by a direct counter current contact chilled lean liquid CO₂ absorbent (e.g., amine) to remove additional carbon dioxide; and
directing the carbon dioxide depleted exhaust stream through another internal channel to a subsequent (optional) internal chamber to be contacted by a direct counter current contact water spray and mass transfer arrangement to prevent entrained liquid CO₂-rich absorbent from leaving the vessel to atmosphere.

Preferably, the walls of the box contactor are made of a combination of material and thickness only required to support up to 7 m (23′) of structure. Preferably, the walls are made of one of or a combination of stainless steel, carbon steel, plastic, or wood. Preferably, the walls of a steel structure are 12 ga (2.7 mm) or thinner. Preferably, the walls of a plastic structure are 3 mm or thinner. According to a preferred embodiment of the present invention, the plastics can be one of or a combination of acrylic, composites, polycarbonate, polypropylene, polyvinyl chloride and polymethylmethacrylate.

According to a preferred embodiment of the present invention, the walls of a wood structure are 3 mm thinner.

Preferably, the walls of wood are covered with an impervious moisture and chemical resistant layer/barrier.

According to a preferred embodiment of the present invention, the internal channels contain a demisting device to agglomerate any entrained liquids from the upstream chamber.

According to another aspect of the present invention, there is provided a method to capture carbon dioxide from a post combustion exhaust, such as from an engine, said method comprising the following steps;
feeding hot exhaust through ducting or piping to a rectangular boxed, and horizontally arranged series of vertical contactor vessels;
cooling the engine exhaust with a direct counter current contact water spray using mass and heat transfer arrangement in an internal chamber;
directing the cooled exhaust through an internal channel to a second internal chamber to be contacted by a direct counter current contact chilled lean liquid CO₂ absorbent (e.g., amine) spray using mass transfer arrangement to capture carbon dioxide yielding a resulting carbon dioxide reduced exhaust stream;
optionally, directing the resulting carbon dioxide reduced exhaust stream through another internal channel to a third or more internal chamber(s) to be contacted at least one more time by a direct counter current contact chilled lean liquid CO₂ absorbent (e.g., amine) to remove additional carbon dioxide resulting in a the carbon dioxide depleted exhaust stream; and
optionally, directing the carbon dioxide depleted exhaust stream through another internal channel to a subsequent internal chamber to be contacted by a direct counter current contact water spray and mass transfer arrangement to prevent entrained liquid CO₂-rich absorbent from being released as a gas into the atmosphere.

The walls of the box contactor are made of a combination of material and thickness only required to support up to 23′ of structure which fits under the road transport shipping limits in Western Canada. The walls can be made of one of or a combination of stainless steel, carbon steel, plastic, or wood. Internal supports can serve as baffles serving two purposes reducing the amount of material and footprint needed to achieve the process requirements. Pressure drops are also reduced with the integrated design which reduces power needs to run the unit translating to less CO₂ generated.

### BRIEF DESCRIPTION OF THE FIGURES

The detailed description will be better understood in conjunction with the accompanying drawings as follows:

FIG. 1 illustrates a general embodiment of a liquid absorbent-based carbon capture process;

FIG. 2 shows an embodiment of the horizontal integrated liquid absorbent-based carbon capture system;

FIG. 3 is a 3D view of the apparatus integrated in the process according to a preferred embodiment of the present invention;

FIG. 4 shows an embodiment of the horizontal integrated liquid absorbent-based carbon capture system with an inter-vessel blower; and

FIG. 5 shows a co-current venturi style water injection system integrated with boxed amine contactor.

### DETAILED DESCRIPTION OF A PREFERRED EMBODIMENT

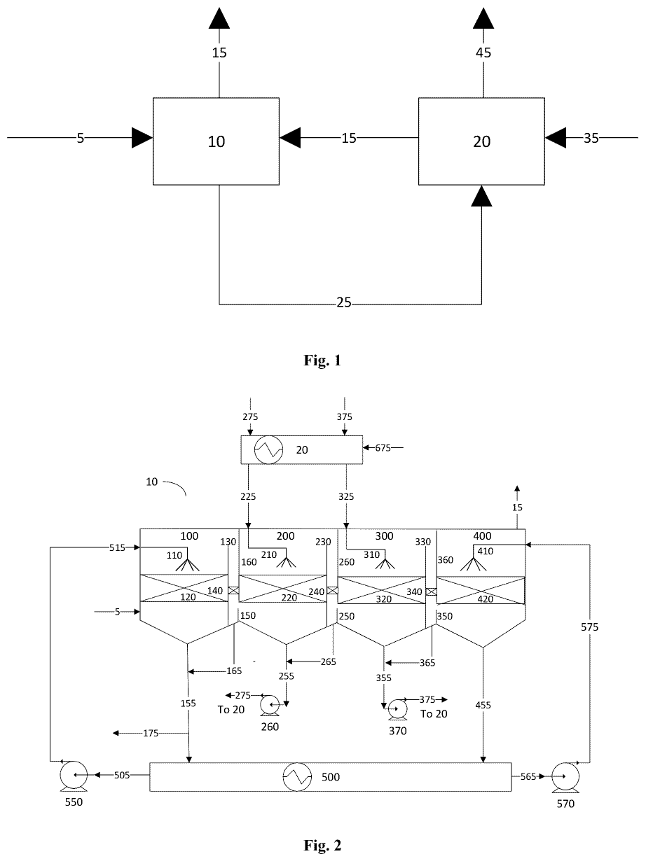

FIG. 1 depicts a liquid absorption carbon capture process according to a preferred embodiment of the present invention, where stream 5 is a feed from any hydrocarbon post-combustion exhaust processed in unit 10. The liquid adsorbent can be any liquid or combination of liquids that preferentially absorb carbon dioxide (CO₂) such as amines (ex. MEA, MDEA, DEA) carbonates (ex. potassium), propanediols (2-Amino-2-methylpropan-1-ol, 2-amino-2-methyl-1,3-propanediol) and/or piperazine. Unit 10 captures carbon dioxide preferentially at low pressures (<101 kpa) and temperatures (<50° C.) with stream 15 leaving as a depleted carbon dioxide vapour stream. Stream 25 leaves unit 10 as a carbon dioxide rich liquid absorbent stream. Stream 25 is routed to unit 20 to remove the CO₂ from liquid adsorbent. Unit 20 operates at elevated temperatures (>50° C.) and pressures (110-400 kPa). Stream 45 leaves unit 20 as a rich CO₂ vapour stream. Stream 15 is a regenerated liquid absorbent that is returned to unit 10 to capture more CO₂. Stream 35 is a make-up stream for any liquid absorbent lost in the process such as in stream 45. Unit 20 can be a conventional tower for liquid absorbent regeneration to separate CO₂ from the liquid absorbent or to reduce the overall size of unit 20 a rotating packed bed or a hollow fibre membrane can be used.

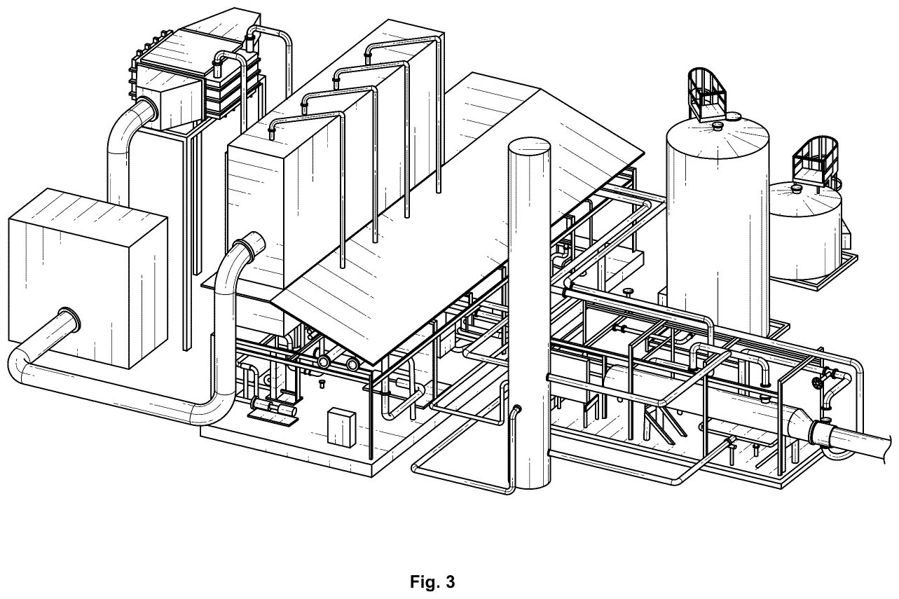

FIG. 2 illustrates the equipment within apparatus 10 according to a preferred embodiment of the present invention. Apparatus 10 represents a novel liquid absorption system that preferentially captures carbon dioxide at low operating pressures below 101 kPag (15 psig) but most effectively in the −2 to 25 kPag range. With the low operating pressure, thinner material can be used for construction of apparatus 10. For steels, the thickness of the apparatus 10 walls can be 2.0 mm or less instead of up to 16 mm (⅝″). Other materials of construction that can be considered are plastics, wood, or any composite material. Liners with external stiffeners can be applied to mitigate any corrosion. The set-up depicted in FIG. 2 can be seen in context of a whole plant as shown in FIG. 3.

Typically, amine contactors are over 30 m high. To keep the wall thickness low, and thus reduce costs of construction, the height of apparatus is limited. The height limit for practical purposes can be the road shipping limit (6.7 m or 22′ in Alberta, British Columbia) to also allow for modular construction and cheaper labour in a fabrication facility than in the field.

With the use of thin material, the apparatus can also be in a rectangular (box) arrangement instead of round as for typical liquid absorbent systems. The rectangular arrangement allows for a smaller footprint for the same flue gas and liquid flow and is better suited for common high-efficiency vessel internal devices that are rectangular in design. The rectangular vessel is also easier to support with both internal and external structures that can be mounted on top of other equipment such as process pump buildings. The internal structural members can also serve as internal baffles (ex. components 130, 230, 330 in FIG. 2) in the process serving two purposes.

In addition, the internal baffle plates to support the mass transfer equipment can act as internal structural stiffening to further reduce the wall thickness and external steel supports.

Stream 5 feeds apparatus 10 near the bottom of vessel 100 and is typically at temperatures higher (>50° C.) than what is desired for optimal liquid absorption (i.e., <40° C.). Stream 5 will comprise of oxygen, nitrogen, carbon dioxide, carbon monoxide, water unconverted methane and other trace hydrocarbon post-combustion products. Stream 515 enters vessel 100 near the top of vessel and is composed of cooler water. Vessel 100 acts as a direct contact cooler. The water at reduced temperatures (down to 17° C. ideally) is directed through a distribution device 110 to counter currently contact the up flowing vapour stream in the mass and heat transfer equipment of 110. Mass and heat transfer equipment is preferably structured packing with the best mass and heat transfer for high vapour and low liquid rates (<50 m³/hr/m²)) and can be more easily installed in a boxed/rectangular arrangement than a round vessel. Other equivalent mass and heat transfer equipment/internals can be trays or random packing. The cooled water reduces the temperature of the vapour stream (˜25° C.) to a point where a portion of the water vapour condenses. The cooling water and the condensed water from the vapour stream are collected at the bottom of vessel 100 and leave via stream 155.

The upward flowing vapour leaving device 120 travels around the inner channel created by internal baffles 130 and 160 and downward out of vessel 100. A demister can either be located at the top of section 100, or located along the downward flow identified as 140, along with the downward flow of vapour through the Internal channel provides de-entrainment for any suspended water droplets. A final change of direction of vapour into the next connect vessel, 200, provides the opportunity for agglomerated water molecules to be collected at the bottom of vessel 100 with baffle 150. This water leaves vessel 100 via stream 165 which is combined to make stream 155. Any excess water is removed through stream 175 with the remaining water entering device 500 that cools the water for reuse. A portion of the water in device 500 is moved to pump 550 through stream 505 and becomes stream 515, the water feed to vessel 100.

Vessel 200 is connected to vessel 100 via internal baffle 160. This arrangement reduces the amount of material needed to fabricate the entire apparatus by sharing common walls. Also, by connecting the vessels with the inner channels, pressure drop for the flowing vapour stream across apparatus 10 (˜4 kPa) is reduced by 33% versus having interconnecting piping/ducting between the separate vessels (˜ 6 kPa).

Vapour enters vessel 200 near the bottom and travels upward through mass and heat transfer equipment, 220, which can be structured packing, random packing, or trays. Liquid CO₂ absorbent enters near the top of vessel 200 via stream 225 and is distributed onto the mass and heat transfer equipment through device 210. Device 210 can be a set of sprays, or a pan or trough style distributor. The downward flowing liquid CO₂ absorbent absorbs the CO₂ in the upward flowing vapour. The liquid CO₂ absorbent is collected in the bottom of vessel 200 and leaves via stream 255. The upward vapour leaving device 220 changes direction and flows downward around internal baffle 230 through the internal channel created by 230 and 260. A demister, 240, agglomerates any entrained liquid absorbent in the vapour stream and the absorbent is collected by baffle 250 and the collected liquid CO₂ absorbent (e.g., amine) leaves apparatus 10 vis steam 265 and combines with stream 255. The collected liquid CO₂ absorbent, rich in CO₂, is pumped in 260 and stream 275 is sent to unit 20 for regeneration and CO₂ release and collection. The regenerated liquid CO₂ absorbent becomes streams 225 and is reused in vessel 200.

If required, vessel 300 acts as a second, CO₂ removal step and follows the same steps as in vessel 200. Vapour enters vessel 300 near the bottom and travels upward through mass transfer equipment, 320, which can be structured packing, random packing, or trays. Liquid absorbent enters near the top of vessel 300 via stream 325 and is distributed onto the mass and heat transfer equipment through device 310. Device 310 can be a set of sprays, or a pan or trough style distributor. The downward flowing liquid CO₂ absorbent absorbs additional CO₂ in the upward flowing vapour. The liquid CO₂ absorbent is collected in the bottom of vessel 300 and leaves via stream 355. The upward vapour leaving device 320 changes direction and flows downward around internal baffle 330 through the internal channel created by 330 and 360. A demister, 340, agglomerates any entrained liquid CO₂ absorbent in the vapour stream and the absorbent is collected by baffle 350 and the collected liquid CO₂ absorbent leaves apparatus 10 vis steam 365 and combines with stream 355. The collected liquid CO₂ absorbent, rich in CO₂, is pumped in 360 and stream 375 is sent to unit 20 for regeneration and CO₂ collection. The regenerated liquid absorbent becomes streams 325 and is reused in vessel 300.

Table 1 provides the temperatures, pressures, and key components (CO₂, water) to be treated of the exhaust streams flowing through the apparatus as described above in FIG. 2. Of note, the pressure drop across each vessel is 1 kPa, 67% of water is removed in vessel 100 with the exhaust temperature reduced to 25° C. CO₂ is removed by 41% and 91% in vessels 200 and 300 respectively, for an overall CO₂ removal of 95%. The water wash section, 400, captures entrained liquid absorbent and removes 16% of the water in the exhaust. The CO₂ rich stream 45 is typically compressed and dehydrated to be sent for sequestration or for chemical processing.

TABLE 1
Various parameters at various points in system of FIG. 2

| | Exhaust Gas Streams in FIG. 2 | | | | |
|---|---|---|---|---|---|
| | Stream | | | | Stream |
| | 5 into | Stream | Stream | Stream | 15 out of |
| | 100 | into 200 | into 300 | into 400 | 400 |
| Temperature (° C.) | 488 | 25 | 43 | 40 | 37 |
| Pressure (kPa) | 98 | 97 | 96 | 95 | 94 |
| Flow (kg/hr) | 98580 | 94600 | 93800 | 88600 | 87900 |
| CO₂ (kg/hr) | 8340 | 8340 | 4930 | 430 | 430 |
| Water (kg/hr) | 5980 | 2000 | 4640 | 3800 | 3200 |
| Other vapours (kg/hr) | 84260 | 84260 | 84230 | 84370 | 84270 |
| Pressure Drop (kPa) | — | 1 | 1 | 1 | 1 |
| per vessel | | | | | |
| % Water removed | — | 67% | — | — | 16% |
| per vessel | | | | | |
| % CO₂ | — | — | 41% | 91% | — |
| removed per vessel | | | | | |
| Total CO₂ | — | — | — | 95% | — |
| removed from exhaust | | | | | |

Although FIG. 2 shows two CO₂ absorber steps (i.e., vessel 200 and vessel 300), an embodiment of apparatus 10 may involve additional vessel sections to increase CO₂ absorption or for additional gas/liquid separation or gas treating.

If required, vessel 400 acts as a water wash to collect any entrained liquid CO₂ absorbent that may end up vented to atmosphere out of apparatus 10 via stream 15. Vessel 400 follows the same steps as vessel 100 which also uses water. Vapour enters vessel 400 near the bottom and travels upward through mass transfer equipment, 420, which can be structured packing, random packing, or trays. Cooled water enters near the top of vessel 400 via stream 425 and is distributed onto the mass transfer equipment through device 410. Device 410 can be a set of sprays, or a pan or trough style distributor. The downward flowing water removes any entrained liquid CO₂ absorbent in the upward flowing vapour. The upward vapour leaves vessel 400 and process 10 via stream 15. Stream 15 typically is released to atmosphere. The water is collected in the bottom of vessel 400 and leaves via stream 455. Stream 455 is sent to device 500 for treatment and cooling for reuse in vessel 400 as stream 565. Stream 565 is pumped through 570 and stream 575 re-enters vessel 400.

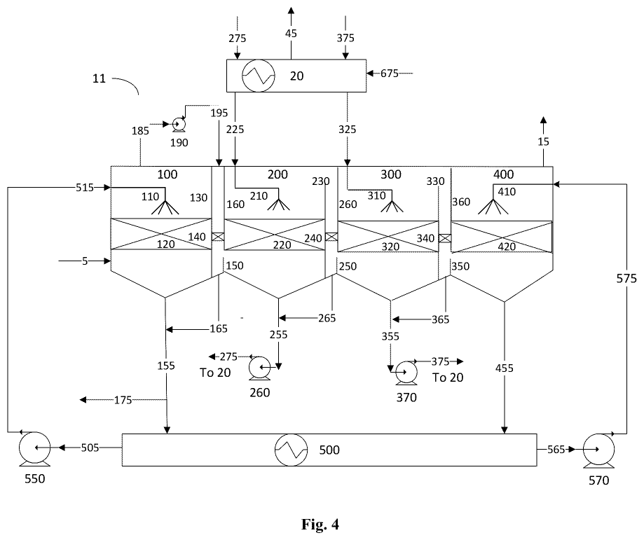

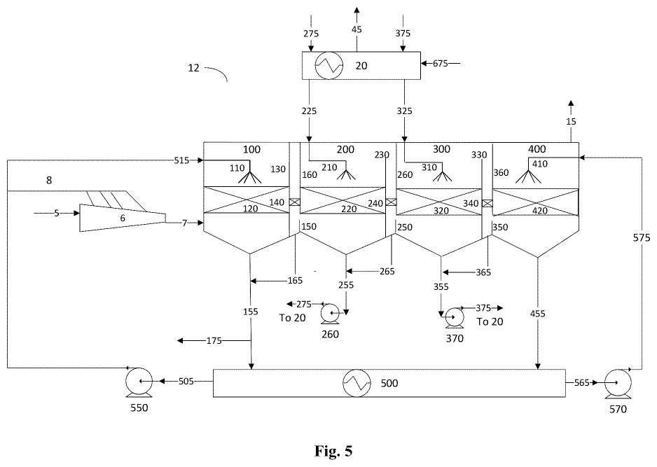

In another embodiment, as shown in FIG. 4, apparatus 11 allows for the cooled flue gas to leave vessel 100 in stream 185 and be directed to a blower, 190, for additional pressure boost to go through the remaining sections. The stream 195 is returned to the internal channel between 130 and 160. The blower outlet may be cooled and directed to an additional gas scrubber compartment within the rectangular suction.

In a further embodiment, FIG. 5 shows an improvement to the direct contact cooler in vessel 100. Water, via a manifold of nozzles, shown as 8, is injected into ducting 6 in the direction of the exhaust flow, co-currently feeding apparatus 12. Spray nozzles provide a motive force with the water to help move the exhaust 5 into stream 7 through apparatus 12 removing the need for a blower. The addition of water in this fashion also reduces or can remove vessel 100 by providing direct cooling of the exhaust in the transport ducting in 6.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

1. A process to capture carbon dioxide from post-combustion exhaust, such as from an engine, that only requires thin-walled vessels and reduces the number of vessel walls by sharing walls between process steps comprising:
direct contact cooling and water condensation and removal in a first chamber;
liquid absorption to capture carbon dioxide in one or more chambers; and
water wash to prevent any liquid absorbent from leaving with the exhaust gas;
integrated with water recycle and liquid absorbent regeneration.

2. The process of claim 1 where the pressure drop across each step is less than 1.5 kPa.

3. The process of claim 1 where the pressure drop across the process is less than 6 kPa.

4. The process of claim 1 where the vessel walls are thinner than 2.7 mm.

5. The process of claim 1 where the vessel height is less than the road transport height limit, 7 m.

6. The process of claim 1 where the vessel material can be steel, wood, or plastic.

7. The process of claim 1 where the liquid absorbent can be a combination of one or all of amine, carbonate, propanediol and piperazine.

8. The process of claim 1 where internal supports also serve as process baffles.

9. The process of claim 1 where the internal channels contain a demisting device to agglomerate any entrained liquids from the upstream chamber.

10. An apparatus to capture carbon dioxide from a post combustion exhaust, such as from an engine, comprising;
feeding hot exhaust through ducting or piping to a rectangular boxed, and horizontally arranged series of vertical contactor vessels;
cooling the engine exhaust with a direct counter current contact water spray using mass and heat transfer arrangement in an internal chamber;
directing the cooled exhaust through an internal channel to a second internal chamber to be contacted by a direct counter current contact chilled lean liquid CO₂ absorbent (e.g., amine) spray using mass transfer arrangement to capture carbon dioxide;
directing the carbon dioxide reduced exhaust stream through another internal channel to a third or more internal chamber(s) to be contacted a second or more time(s) by a direct counter current contact chilled lean liquid CO₂ absorbent (e.g., amine) to remove additional carbon dioxide; and
directing the carbon dioxide depleted exhaust stream through another internal channel to a subsequent internal chamber to be contacted by a direct counter current contact water spray and mass transfer arrangement to prevent entrained liquid CO₂-rich absorbent from leaving the vessel to atmosphere.

11. The apparatus of claim 10, where the walls of the box contactor are made of a combination of material and thickness only required to support up to 7 m (23′) of structure.

12. The apparatus of claim 11, where the walls are made of one of or a combination of stainless steel, carbon steel, plastic, or wood.

13. The apparatus according to claim 12, where the walls of a steel structure are 12 ga (2.7 mm) or thinner.

14. The apparatus according to claim 13, where the walls of a plastic structure are 3 mm or thinner.

15. The apparatus according to claim 14, where the plastics can be one of or a combination of acrylic, composites, polycarbonate, polypropylene, polyvinyl chloride and polymethylmethacrylate.

16. The apparatus according to claim 12, where the walls of a wood structure are 3 mm thinner.

17. The apparatus according to claim 16, where the walls of wood are covered with an impervious moisture and chemical resistant layer/barrier.

18. The apparatus according to claim 17, where the internal channels contain a demisting device to agglomerate any entrained liquids from the upstream chamber.

19. The process of claim 1 where the regeneration of the liquid absorbent is accomplished using a rotating packed bed absorber.

20. The process of claim 1 where the regeneration of the liquid absorbent is accomplished using a hollow fibre membrane.

21. A method to capture carbon dioxide from a post combustion exhaust, such as from an engine, said method comprising the following steps;
feeding hot exhaust through ducting or piping to a rectangular boxed, and horizontally arranged series of vertical contactor vessels;
cooling the engine exhaust with a direct counter current contact water spray using mass and heat transfer arrangement in an internal chamber;
directing the cooled exhaust through an internal channel to a second internal chamber to be contacted by a direct counter current contact chilled lean liquid CO₂ absorbent (e.g., amine) spray using mass transfer arrangement to capture carbon dioxide yielding a resulting carbon dioxide reduced exhaust stream; and
providing at least one of the following steps:
directing the resulting carbon dioxide reduced exhaust stream through another internal channel to a third or more internal chamber(s) to be contacted at least one more time by a direct counter current contact chilled lean liquid CO₂ absorbent (e.g., amine) to remove additional carbon dioxide resulting in a the carbon dioxide depleted exhaust stream; and
directing the carbon dioxide depleted exhaust stream through another internal channel to a subsequent internal chamber to be contacted by a direct counter current contact water spray and mass transfer arrangement to prevent entrained liquid CO₂-rich absorbent from being released as a gas into the atmosphere.
